(19) United States
(12) Patent Application Publication
(10) Pub. No.: US 2014/0287376 A1
(43) Pub. Date: Sep. 25, 2014

(54) ORTHODONTIC BRACKET PLACEMENT USING BRACKET GUIDE FEATURES

(71) Applicants: Bruce Willard Hultgren, Victoria, MN (US); Michael Craig Marshall, Sheboygan, WI (US)

(72) Inventors: Bruce Willard Hultgren, Victoria, MN (US); Michael Craig Marshall, Sheboygan, WI (US)

(21) Appl. No.: 14/204,953

(22) Filed: Mar. 11, 2014

Related U.S. Application Data
(60) Provisional application No. 61/780,331, filed on Mar. 13, 2013.

(51) Int. Cl. A61C 7/14; A61C 7/00; A61C 9/00

(52) U.S. Cl. CPC A61C 7/146; A61C 9/0046; A61C 7/002
USPC 433/24; 433/72; 433/29

(57) ABSTRACT

Bracket guide features and use of such features to guide placement of orthodontic brackets.

### CROSS REFERENCE TO RELATED APPLICATION

This application claims priority to U.S. Ser. No. 61/780,331 filed on Mar. 13, 2013, titled ORTHODONTIC BRACKET PLACEMENT USING BRACKET GUIDE FEATURES, the disclosure of which is hereby incorporated by reference in its entirety.

### BACKGROUND

Dental braces can be used to correct various teeth deformities. For example, braces can be used to correct spaces between teeth or to straighten crooked teeth. Dental braces typically include brackets and wires. The brackets are placed on the patient's teeth. The brackets are connected using the wires, which are tightened in order to facilitate movement of the teeth to a desired position and orientation.

### SUMMARY

In general terms, this disclosure is directed to orthodontic bracket placement. In one possible configuration and by non-limiting example, bracket guide features are used to guide the placement of the orthodontic brackets.

One aspect is a method of guiding placement of a bracket, the method comprising: obtaining an electronic model of a dentition, the electronic model defining at least a front surface of a tooth; and modifying the electronic model to add at least one bracket guide feature to the electronic model at the front surface of the tooth, wherein the bracket guide feature identifies a proper position on the front surface for placement of the bracket.

Another aspect is a physical model of a dentition, the physical model comprising: physical models of a plurality of teeth; and one or more bracket guide features arranged on one or more of the teeth, wherein the bracket guide features are physical structures integral with the physical models of the plurality of teeth.

A further aspect is an apparatus for placing bracket guide features on a model dentition to assist in accurate bracket placement, the system comprising: a dentition scanner that outputs an electronic model of a dentition; and a tray forming station wherein the tray forming station further includes a bracket guide feature placement engine for placing bracket guide features on the electronic model of the dentition, and a three-dimensional printer for printing a physical model of the dentition with the bracket guide features appropriately placed.

Another aspect is a method of placing orthodontic brackets on a patient using bracket guide features, the method comprising: scanning a patient's dentition to obtain an electronic model of the dentition including at least one tooth in a pre-treatment position; uploading the electronic model of the dentition in a bracket guide feature placement engine; adjusting the at least one tooth to a desired post-treatment position; placing bracket guide features on the at least one tooth in the desired post-treatment position; readjusting the at least one tooth of the electronic model of the dentition with the bracket guide features to the pre-treatment position; generating a physical model of the tooth with bracket guide features in the pre-treatment position using a three-dimensional printer; inserting at least one bracket on the physical model of the at least one tooth using the bracket guide features; attaching an indirect bonding tray to the at least one bracket on the physical model of the at least one tooth; removing the indirect bonding tray and the at least one bracket from the physical model of the at least one tooth; placing the indirect bonding tray and the at least one bracket on the patient; and removing the indirect bonding tray from the at least one bracket.

### BRIEF DESCRIPTION OF THE DRAWINGS

FIG. 1 is a schematic block diagram illustrating an example system for making and using bracket guide features.

FIG. 2 is a graphical representation of an example electronic model of a dentition generated by the system shown in FIG. 1.

FIG. 3 is a block diagram illustrating an example architecture of a computing device, which can be used to implement various aspects of the system shown in FIG. 1.

FIG. 4 is a schematic block diagram illustrating an example of a bracket guide feature placement engine of the system shown in FIG. 1.

FIG. 5 is a flow chart showing an example method of placing bracket guide features on an electronic model of a dentition.

FIG. 6 is a graphical representation of an example of an electronic model of a dentition in a pre-treatment configuration.

FIG. 7 is a graphical representation of an example of the electronic model of a dentition, shown in FIG. 6, in a post-treatment configuration.

FIG. 8 is a diagram illustrating data stored for the electronic model of the dentition identifying points of the model in both the pre-treatment configuration and in the post-treatment configuration.

FIG. 9 is a schematic diagram illustrating the electronic model of the dentition in the post-treatment configuration and further illustrating bracket guide feature coordinates.

FIG. 10 is a schematic diagram illustrating an example mapping operation performed by an electronic bracket guide feature placement engine of the system shown in FIG. 1.

FIG. 11 is a schematic diagram illustrating the electronic model of the dentition, as shown in FIG. 9, arranged in the pre-treatment configuration.

FIG. 12 is a side view of an example physical model of a dentition with protruding bracket guide features.

FIG. 13 is a top view of the example of a physical model of a dentition, as shown in FIG. 12.

FIG. 14 is a side view illustrating another example of a physical model of a dentition, having indented bracket guide features.

FIG. 15 is a top view of the example of the physical model of a dentition, shown in FIG. 14.

FIG. 16 is a schematic front view of an example of a physical model of a dentition including bracket guide features.

FIG. 17 is a flow chart illustrating example operations performed at a tray assembly station.

FIG. 18 is a schematic front view of the example physical model of a dentition, shown in FIG. 16, including brackets installed between the bracket guide features.

FIG. 19 is a schematic side cross-sectional view of an example indirect bonding tray formed around the physical model of the dentition and the brackets, as shown in FIG. 18.

FIG. 20 is another schematic side cross-sectional view of the example indirect boding tray shown in FIG. 19, being removed from the physical model of the dentition.

FIG. 21 is another schematic side cross-sectional view of the example indirect bonding tray shown in FIG. 20, being positioned on a patient's dentition.

FIG. 22 is a schematic front view of the patient's dentition having the brackets and accompanying wires properly placed on a patient's teeth.

FIG. 23 illustrates the patient's teeth after orthodontic treatment is complete.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

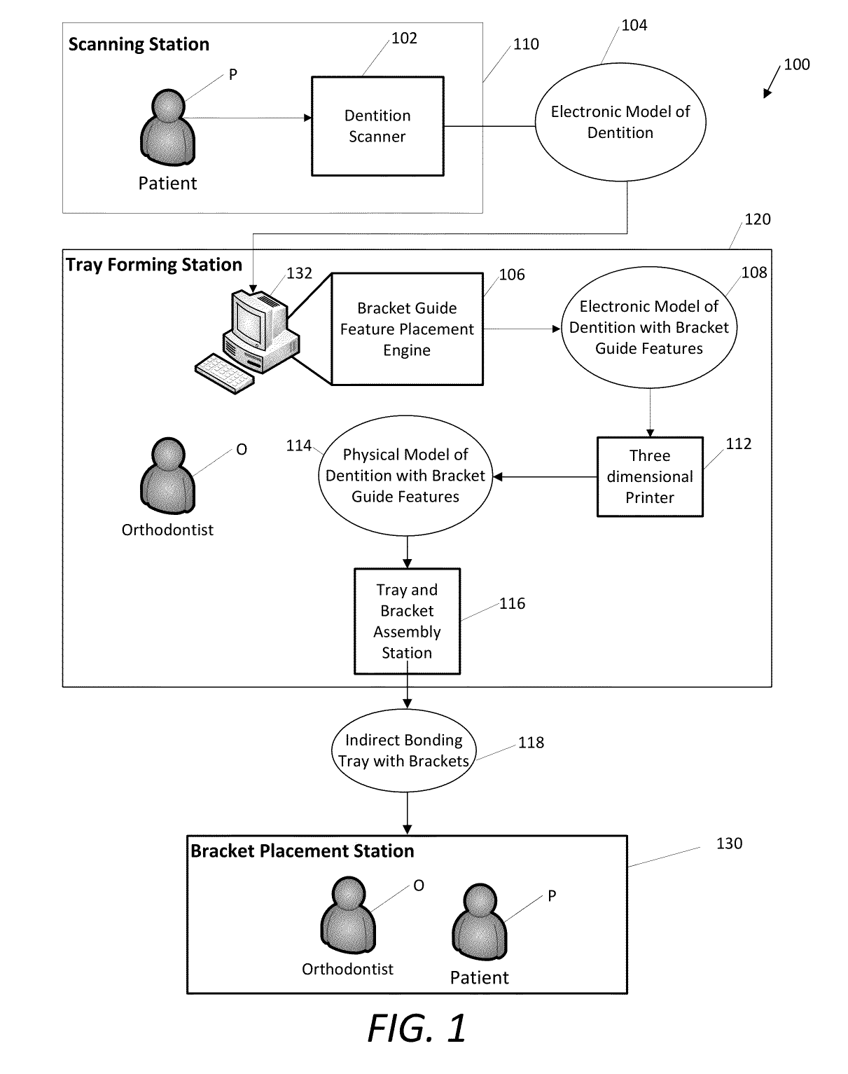

FIG. 1 is a schematic block diagram illustrating an example system 100 for making and using bracket guide features. In this example, the system 100 includes a scanning station 110, a tray forming station 120, and a bracket placement station 130. The example scanning station 110 includes a dentition scanner 102 that generates an electronic model 104 of a patient's dentition. The example tray forming station 120 includes a computing device 132, a bracket guide feature placement engine 106, an electronic model of dentition with bracket guide features 108, a three-dimensional printer 112, a physical model 114 of dentition with bracket guide features, and a tray assembly station 116. The resulting indirect bonding tray 118 with brackets is used in the bracket placement station 130. Also illustrated in FIG. 1 are examples of several people who may be involved with the system 100, including the patient P and orthodontist O.

The scanning station 110 operates to perform a scan of the patient's P dentition, such as using a dentition scanner 102. The scanner 102 can be one of several types, for example, including an intraoral scanner, a table top laser scanner, or a computed tomography (CT) scanner. In some embodiments the scanner is a three-dimensional laser scanner that generates data defining a polygonal mesh forming the electronic model 104 of the dentition. In some embodiments, the scanner 102 first projects points onto the surface, here, the patient's dentition. The reflection of these points off of the patient's dentition enables the scanner to obtain the location of points in a three-dimensional coordinate system (x, y, z). These points are used to create a point cloud corresponding to the contours of the patient's dentition. Next, the scanning system creates a polygonal mesh by using the point cloud to create triangles that approximate the surface contours. Examples of scanners 102 include a 3D scanner, intraoral scanner, 3D intraoral scanner, or 3D dental scanner. The electronic model 104 may be obtained by placing the scanner in the patient's mouth, by scanning a dental impression, or by scanning from outside of the mouth. Several examples of possible scanners 102 include: the TRIOS Intra Oral Digital Scanner, the Lava Chairside Oral Scanner C.O.S., the iTero, the Cerec AC, the Cyrtina IntraOral Scanner, a cone beam CT (CBCT) scanner, and an industrial CT scanner.

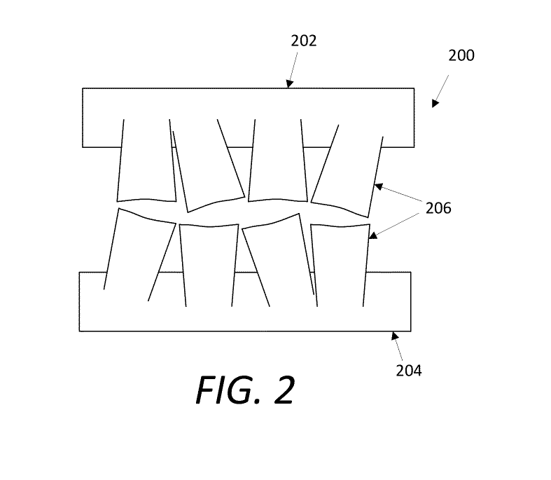

The electronic model 104 of the dentition includes, for example, the upper and lower jaw, and shows the undesired relative positioning of the teeth that needs to be corrected. Examples of such electronic models 104 are illustrated and described in more detail herein, such as in FIG. 2.

The tray forming station 120 generates an indirect bonding tray 118 with brackets in order to aid in placing brackets on a patient P. The example tray forming station 120 includes a computing device 132 including a bracket guide feature placement engine 106, a three-dimensional printer 112, and a tray assembly station 116.

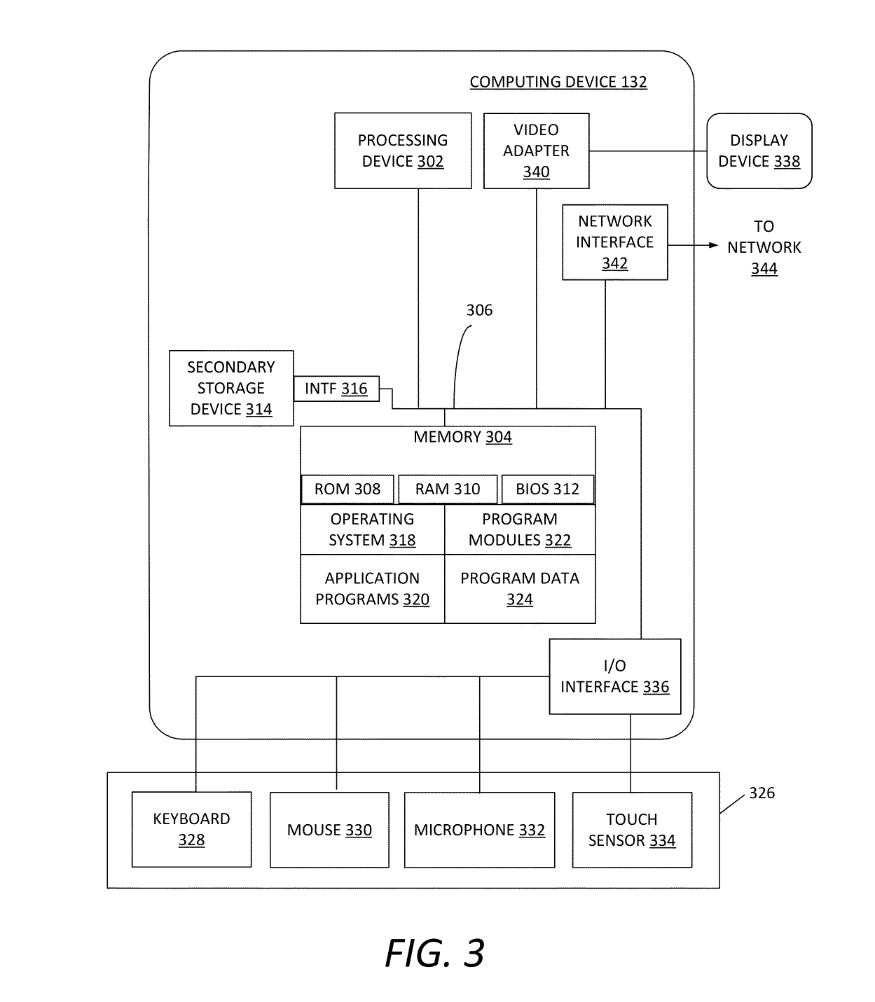

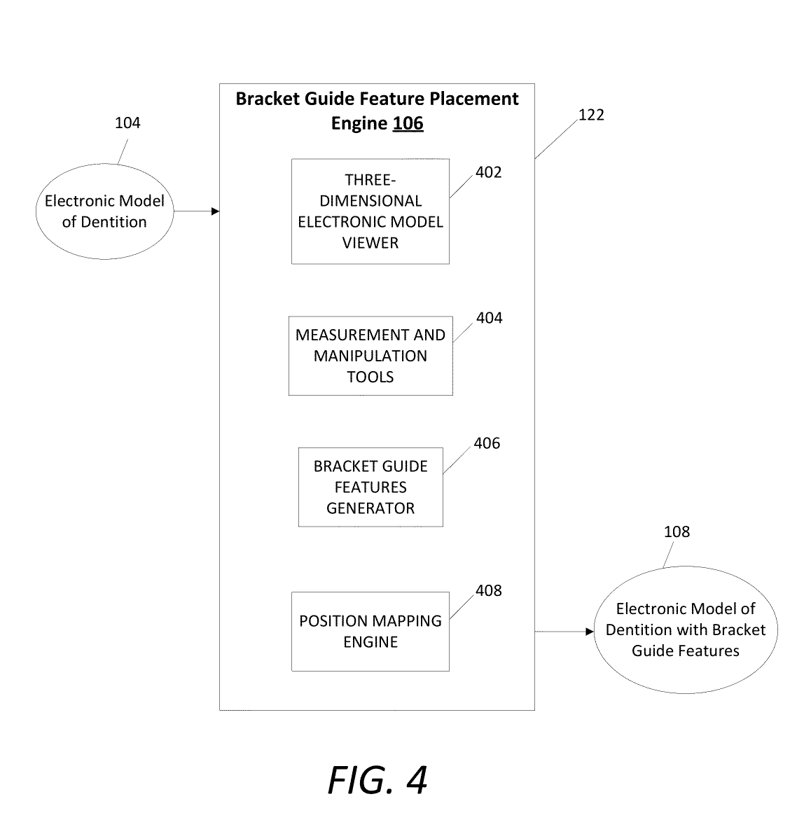

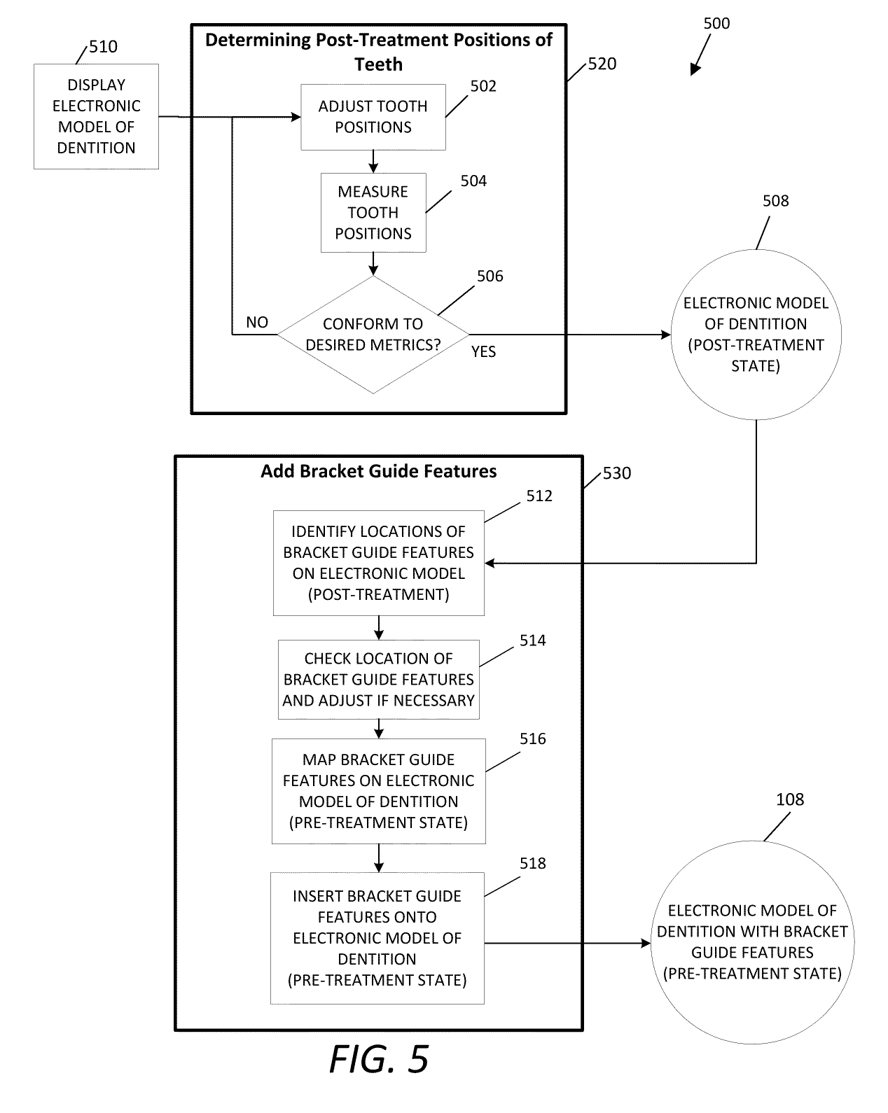

The computing device 132 operates to generate an electronic model of a dentition with bracket guide features 108. An example of the computing device 132 is illustrated and described in more detail herein with reference to FIG. 3. In some embodiments, the computing device 132 includes a bracket guide feature placement engine 106. The user, such as an orthodontist, interacts with the computing device 132 and bracket guide feature placement engine 106 to adjust the teeth and insert bracket guide features at appropriate locations to form an electronic model of a dentition with bracket guide features 108. An example of the bracket guide feature placement engine 106 is illustrated and described in more detail here in with reference to FIGS. 4-5.

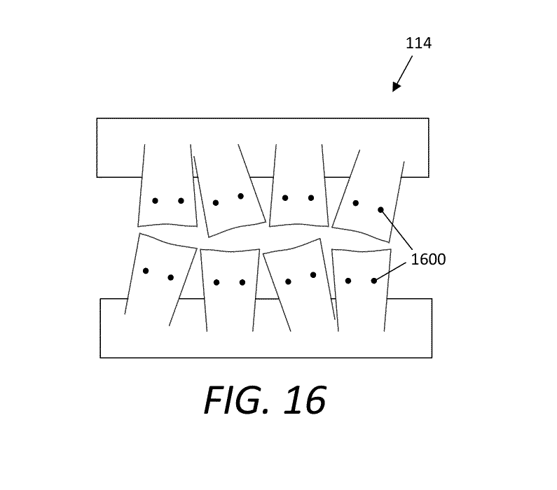

The three-dimensional printer 112 operates to generate a physical model 114 of the dentition with bracket guide features from the electronic model of the dentition with bracket guide features 108. In some embodiments, the three-dimensional printer 112 uses an additive process of depositing successive layers of material onto a surface to manufacture a desired object. Electronic three-dimensional models provide the blueprint for the three-dimensional printer: software takes the object within the electronic model and creates thin, horizontal cross-sections which can be used to direct the printer to deposit material at locations defined by the electronic model. Examples of additive technologies include selective laser sintering, fused deposition modeling, stereo lithography, powder bed and inkjet head 3D printing, and plaster-based 3D printing. An example of a three-dimensional printer 112 is the ProJect line of 3D printers available from 3DSystems, Inc. of Rock Hill, S.C. Other examples of three-dimensional printers 112 are those available from Stratysis, Inc. of Eden Prairie, Minn., and Objet Ltd of Rehovot, Israel. In some embodiments the three-dimensional printer 112 is an inkjet printer that utilizes prints using a polymeric material. In another embodiment, the printer 112 is a stereo lithography printer that utilizes a photo curable polymer. Other embodiments use other three-dimensional printers. An example of a physical model 114 created by the three-dimensional printer 112 from the corrected arch dentition model 124 are shown in FIGS. 16 and 18-21.

The tray assembly station 116 uses the physical model 114 of the dentition with bracket guide features to form an indirect bonding tray with brackets 118.

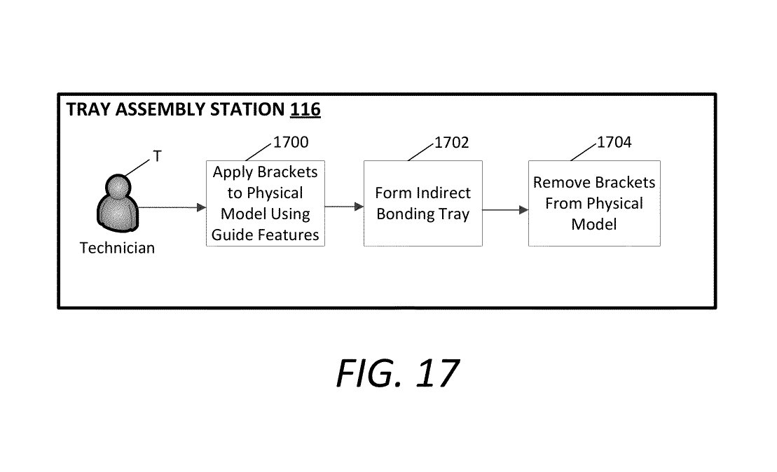

Examples of the tray forming station 120 are illustrated and described in further detail herein with reference to FIGS. 2-16. In some embodiments, an orthodontist O performs the procedure of placing brackets on the patient P in the bracket placement station 130. During an exemplary procedure, the orthodontist O aligns the indirect bonding tray with brackets 118 on the patient's P teeth. The orthodontist O then removes the indirect bonding tray from the brackets, leaving only brackets on the patient's P teeth. Examples of the bracket placement station 130 are illustrated and described in further detail herein with reference to FIGS. 17-23.

FIG. 2 is a graphical representation of an example electronic model of a dentition 200 generated by the dentition scanner 102, shown in FIG. 1. The illustrated electronic model 200 shows an example of the patient's dentition scanned before treatment. The electronic model 200 includes the patient's upper jaw 202, lower jaw 204, teeth 206, and also identifies various deformities such as gaps between, and crookedness of, teeth.

FIG. 3 illustrates an exemplary architecture of a computing device that can be used to implement aspects of the present disclosure. The computing device illustrated in FIG. 3 can be used to execute the operating system, application programs, and software modules (including the software engines) described herein.

The computing device 132 includes, in some embodiments, at least one processing device 302, such as a central processing unit (CPU). A variety of processing devices are available from a variety of manufacturers, for example, Intel or Advanced Micro Devices. In this example, the computing device 132 also includes a system memory 304, and a system bus 306 that couples various system components including the system memory 304 to the processing device 302. The system bus 306 is one of any number of types of bus structures including a memory bus, or memory controller; a peripheral bus; and a local bus using any of a variety of bus architectures.

Examples of computing devices suitable for the computing device 132 include a desktop computer, a laptop computer, a tablet computer, a mobile computing device (such as a smart phone, an iPod® or iPad® mobile digital device, or other mobile devices), or other devices configured to process digital instructions.

The system memory 304 includes read only memory 308 and random access memory 310. A basic input/output system 312 containing the basic routines that act to transfer information within computing device 132, such as during start up, is typically stored in the read only memory 308.

The computing device 132 also includes a secondary storage device 314 in some embodiments, such as a hard disk drive, for storing digital data. The secondary storage device 314 is connected to the system bus 306 by a secondary storage interface 316. The secondary storage devices 314 and their associated computer readable media provide nonvolatile storage of computer readable instructions (including application programs and program modules), data structures, and other data for the computing device 132.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 316 or memory 304, including an operating system 318, one or more application programs 198, other program modules 322 (such as the software engines described herein), and program data 324. The computing device 132 can utilize any suitable operating system, such as Microsoft Windows™, Google Chrome™, Apple OS, and any other operating system suitable for a computing device.

In some embodiments, a user provides inputs to the computing device 132 through one or more input devices 326. Examples of input devices 326 include a keyboard 328, mouse 330, microphone 332, and touch sensor 334 (such as a touchpad or touch sensitive display). Other embodiments include other input devices 326. The input devices are often connected to the processing device 302 through an input/output interface 336 that is coupled to the system bus 306. These input devices 326 can be connected by any number of input/output interfaces, such as a parallel port, serial port, game port, or a universal serial bus. Wireless communication between input devices and the interface 336 is possible as well, and includes infrared, BLUETOOTH® wireless technology, 802.11a/b/g/n, cellular, or other radio frequency communication systems in some possible embodiments.

In this example embodiment, a display device 338, such as a monitor, liquid crystal display device, projector, or touch sensitive display device, is also connected to the system bus 306 via an interface, such as a video adapter 340. In addition to the display device 338, the computing device 132 can include various other peripheral devices (not shown), such as speakers or a printer.

When used in a local area networking environment or a wide area networking environment (such as the Internet), the computing device 132 is typically connected to the network 344 through a network interface 342 as an Ethernet interface. Other possible embodiments use other communication devices. For example, some embodiments of the computing device 132 include a modem for communicating across the network.

The computing device 132 typically includes at least some form of computer readable media. Computer readable media includes any available media that can be accessed by the computing device 132. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 132. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 2 is also an example of programmable electronics, which may include one or more such computing devices, and when multiple computing devices are included, such computing devices can be coupled together with a suitable data communication network so as to collectively perform the various functions, methods, or operations disclosed herein.

FIG. 4 is a schematic block diagram illustrating an example of a bracket guide feature placement engine 400 of the system shown in FIG. 1. In this example, the bracket guide feature placement engine 106 includes a three-dimensional electronic model viewer 402, measurement and manipulation tools 404, a bracket guide features generator 406, and a position mapping engine 408. Also illustrated in FIG. 4 are the electronic model of dentition 104 and the electronic model of dentition with bracket guide features 108.

The three-dimensional electronic model viewer 402 operates to display the electronic model of dentition 104 generated by the dentition scanner 102 to a user, such as the orthodontist O, so that the user can view it. In one embodiment, the electronic model viewer 402 reads the received electronic model 104 data and renders the electronic model 104 viewable in the computing device 132. In some embodiments, the electronic model viewer 402 converts the file type of the received electronic model 104 into another format readable by the computing device 132, prior to displaying the electronic model of dentition 104 to the user O. An example of a three-dimensional electronic model viewer is EMODEL® Viewer, such as version 8.5, available from GeoDigm Corporation, of Falcon Heights, Minn.

The measurement and manipulation tools 404 enable the user O to reposition the relative alignment of the patient's teeth 206. In one embodiment, the tools 404 render the teeth 206 independently maneuverable. In some embodiments, the user O utilizes the tools 404 to adjust the relative positions of the teeth 206. The user O can reposition the teeth 206 in any of the x-, y-, or z-planes to correct the deformities. In another embodiment, the tools 404 measure the relative positions between two or more corresponding points on both the upper jaw 202 and lower jaw 204. In this embodiment, the tools 404 are programmed to automatically compare the positions with a pre-defined metric and automatically position the teeth 206 according to the pre-defined metric. Alternatively, the tools 404 can be used to instruct the user to continue repositioning the teeth 206 if the current relative positioning does not satisfy the metrics. In some embodiments, the measurement and manipulation tools 404 are part of the Modified Bite Module of the EMODEL® Viewer software application. For example, manipulation of the electronic model can be accomplished using the rotate x-y-z and translate x-y-z functions. Measurement can be accomplished, for example, using the measurement grid function. In another possible embodiment, the measurement and manipulation tools 404 can be configured to automatically configure the teeth 206 according to predefined criteria, or by user-provided criteria, such as desired measurements between particular points.

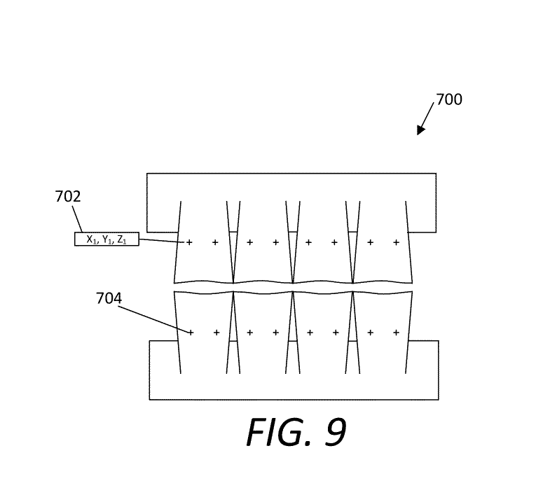

The bracket guide features generator 406 operates to add the bracket guide features to the electronic model 104 after the position of the teeth 206 has been corrected in the electronic model 104. The bracket guide features generator 406 is illustrated and described in more detail with reference to FIGS. 5 and 9, for example.

The position mapping engine 408 operates to map the location of the bracket guide features of the electronic model 104 between post-treatment coordinates and pre-treatment coordinates. The position mapping engine 408 is illustrated and described in more detail with reference to FIGS. 5, 8-11.

FIG. 5 is a flow chart showing an example method 500 of placing bracket guide features on an electronic model of a dentition. In this example, the method 500 includes operation 510 and methods 520 and 530. The method 500 identifies and places bracket guide features on an electronic model of a dentition 104 with various tooth deformities.

Operation 510 is performed to enable the user to view the electronic model of dentition 104. In some embodiments, operation 510 is performed by the three-dimensional electronic model viewer 402 shown in FIG. 4.

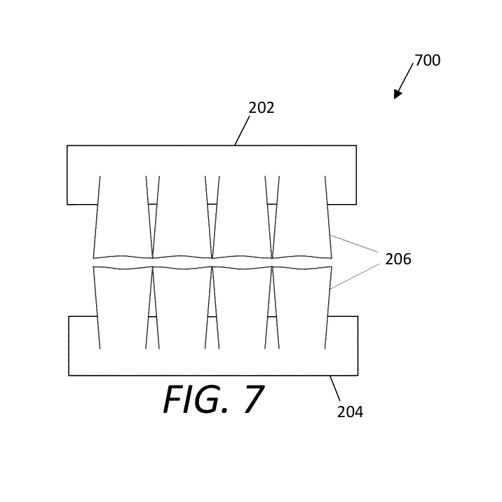

In this example, the method 520 of determining post-treatment positions of teeth is performed to adjust and correct the relative positions of the patient's teeth 206, where the corrected, relative positions are illustrated and described in more detail with reference to FIG. 7. The method 520 includes operations 502, 504, and 506, for example. In some embodiments, the method 520 is performed by the three-dimensional electronic model viewer 402 and the measurement and manipulation tools 404 shown in FIG. 4.

Operation 502 is performed to adjust the relative tooth positions of the dentition to their post-treatment state. In some embodiments, in operation 502, the orthodontist O manually segments each tooth 206 of the electronic model of the dentition 104 and moves each tooth to its final position. In some embodiments, the original position data of the teeth in their pre-treatment states and are stored in a computer readable storage device.

In some embodiments, the operation 504 is performed to measure the relative tooth positions of the electronic model of the dentition 104.

The operation 506 is performed to verify that the relative positioning of the teeth 206 conforms to desired metrics. In some embodiments, pre-defined parameters are stored. An example of pre-defined parameters are metrics related to the required relative horizontal (x-y plane) positions of the teeth 206 needed to correct the observed deformity.

In some embodiments, the operation 506 compares the relative positions of the patient's teeth 206. As an example, if the positions do not correspond to the desired metrics, the operation 506 prompts the user to readjust the relative positions in operation 502 and the process repeats until the teeth 206 are acceptably positioned. In one embodiment, if the relative positions do not conform to the pre-stored metrics, the operation 506 repositions the teeth 206 so that the relative positions satisfy the metric criteria. As another example, if the positions are within acceptable tolerances of the pre-stored metrics, the operation 506 prompts the user to complete the model with operations 530, 512, 516, and 518. An example of a post-treatment electronic dentition 508 is illustrated and described in more detail in FIG. 7.

In this example, method 530 is performed to add bracket guide features on the electronic model. The method 530 includes operations 512, 514, 516, and 518. In some embodiments, the method 530 is performed by the three-dimensional electronic model viewer 402 and the bracket guide features generator 406, shown in FIG. 4. In some embodiments, the method 530 begins when the engine accesses the post-treatment electronic dentition model 508. In some embodiments, the method 530 is performed by a user who is not the orthodontist O, or is performed by another orthodontist, or other person, such as by an assistant or technician.

Operation 512 is performed to identify the locations of the bracket guide features on the electronic model of the dentition 508. In some embodiments, the operation 512 prompts the user to select a type of bracket guide feature from a database containing templates for different bracket guide features. In another embodiment, only a single guide feature configuration is available.

In one embodiment, the operation 512 prompts the user to select a location for the bracket guide feature on a tooth 206, and an input is received from the user. In some embodiments, the operation 512 continues to prompt the user to select locations of additional bracket guide features. This operation 512 is shown and described in more detail in FIG. 9.

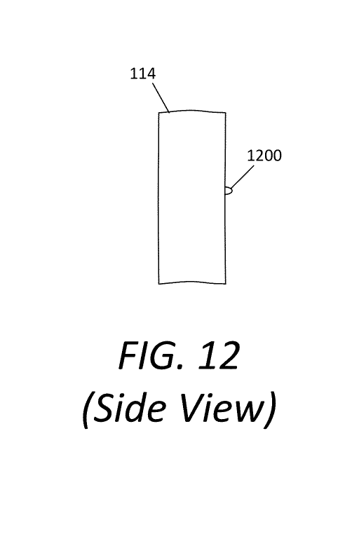

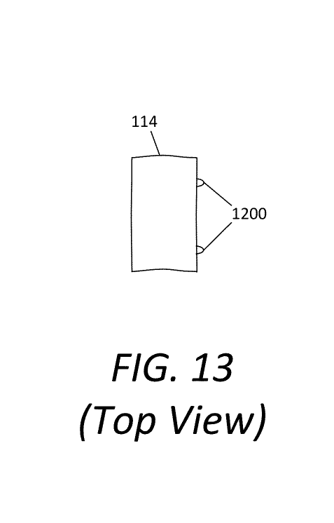

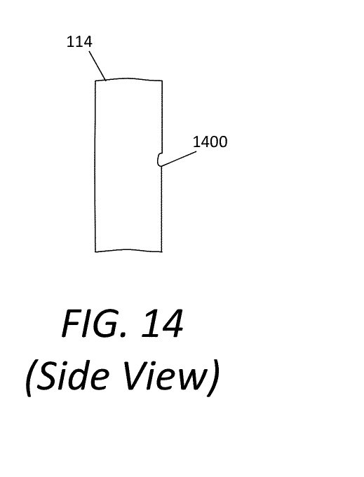

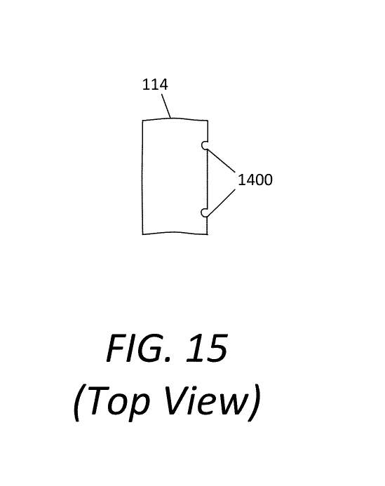

FIGS. 12-13 illustrate an example of bracket guide features as being bumps that protrude from the physical model. FIGS. 14-15 illustrate an example of bracket guide features as being indentations on the surface of the physical model. These are only a few examples. In other possible embodiments, other shapes and configurations of bracket guide features can be used.

Operation 514 is performed in some embodiments to ensure that the bracket guide features are properly placed. In some embodiments, the operation 514 prompts the user to check the location of the bracket guide features created in operation 512. In other embodiments, the operation 514 evaluates the positions and notifies the user that the location of the bracket guide features are not located in appropriate locations. In some embodiments, the operation prompts the user to change the improper locations.

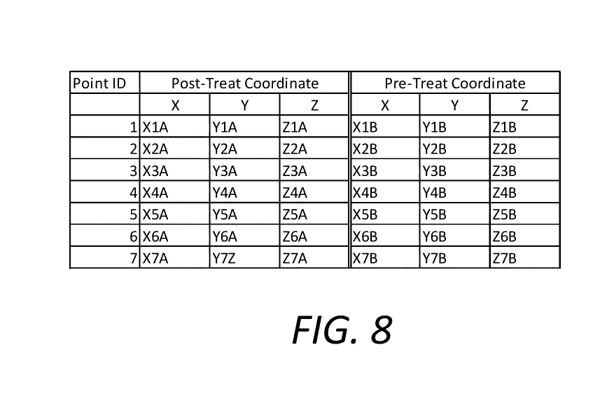

Operation 516 is performed to determine the locations of the bracket guide features of the electronic model of the dentition in the pre-treatment state. Operation 516 calculates and stores the locations of the bracket guide features determined in operations 512 and 514 and maps those respective locations onto an electronic model of the dentition 510 in the pre-treatment state. The mapping feature of operation 516 is shown and described in more detail in FIGS. 8-10.

Operation 518 is performed to place bracket guide features onto the electronic model of the dentition in the pre-treatment state. In this example embodiment, operation 518 places bracket guide features in the location received from operation 516. Once operation 518 is complete, the model 108 is ready for the three-dimensional printer 112.

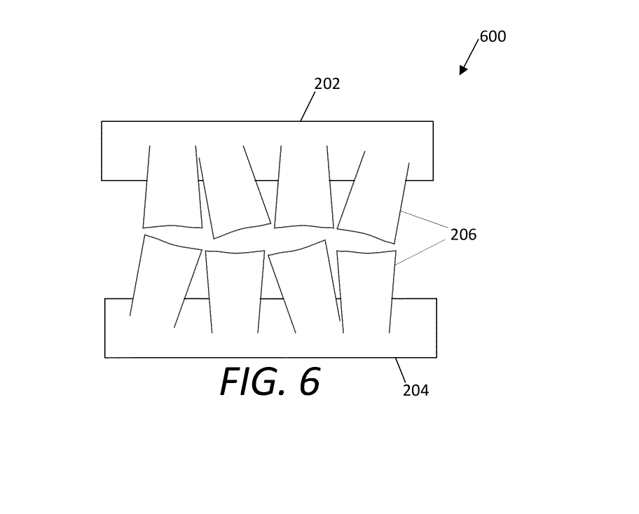

FIG. 6 is a graphical representation of an example of an electronic model of a dentition 600 in a pre-treatment state, such as can be generated by the dentition scanner 102 shown in FIG. 1. In this example, the electronic model 600 includes the upper jaw 202, lower jaw 204, teeth 206, and also identifies various deformities such as gaps between, and crookedness of, teeth.

FIG. 7 is a graphical representation of an example of the electronic model of a dentition, shown in FIG. 6, in a post-treatment configuration, as generated by the method 520. In this example, the electronic model 700 includes the upper jaw 202, lower jaw 204, and teeth 206. This example electronic model 700 depicts the patient's teeth 206 in their post-treatment state.

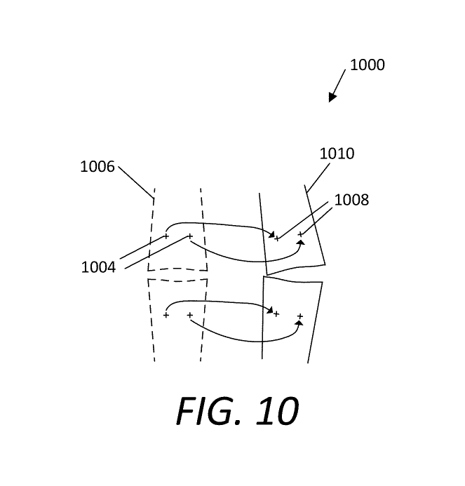

FIG. 8 is a diagram illustrating data stored for the electronic model of the dentition identifying points of the model in both the pre-treatment configuration and in the post-treatment configuration as generated in method 516. In this illustration, operation 516 determines the coordinates of the bracket guide features identified in operations 512 and 514 of a dentition in the post-treatment state and calculates those respective coordinates on the electronic model of the dentition in the pre-treatment state. The method 516 determines the coordinates on an x-y-z plane. The mapping feature of FIG. 8 is shown in more detail in FIGS. 9-10.

FIG. 9 is a schematic diagram illustrating the electronic model of the dentition in the post-treatment configuration and further illustrating bracket guide feature coordinates 702 and 704, such as generated by operations 512 and 514, illustrated and described with reference to FIG. 5.

FIG. 10 is a schematic diagram illustrating an example mapping operation, such as performed by an electronic bracket guide feature placement engine 106. FIG. 10 also illustrates an example of the mapping operation 516 shown in FIG. 5. In this example, the mapping operation 516 calculates and stores the coordinates 1004 of the bracket guide features on each tooth 206 in the post-treatment state 1006. The mapping operation 1000 then calculates and identifies the respective coordinates 1008 of the bracket guide features on each tooth 206 in the pre-treatment state 1010.

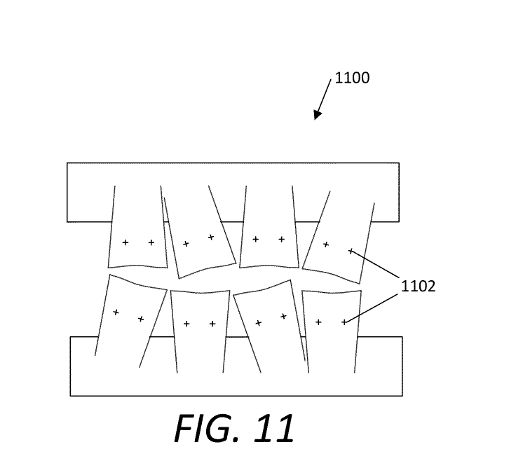

FIG. 11 is a schematic diagram illustrating the electronic model of the dentition 1100, as shown in FIG. 9, arranged in the pre-treatment configuration as generated by method 516. In this example, electronic model of the dentition 1100 includes locations of the coordinates 1102 where the bracket guide features will be placed.

FIG. 12 is a side view of an example physical model 114 of a dentition with protruding bracket guide features 1200.

FIG. 13 is a top view of the example of a physical model of a dentition 114, with protruding bracket guide features 1200, as shown in FIG. 12.

FIG. 14 is a side view illustrating another example of a physical model of a dentition 114, having indented bracket guide features 1400.

FIG. 15 is a top view of the example of the physical model of a dentition 114, with indented bracket guide features 1400, as shown in FIG. 14.

FIG. 16 is a schematic front view of an example of a physical model of a dentition 114 including bracket guide features 1600, as shown in FIGS. 12-15.

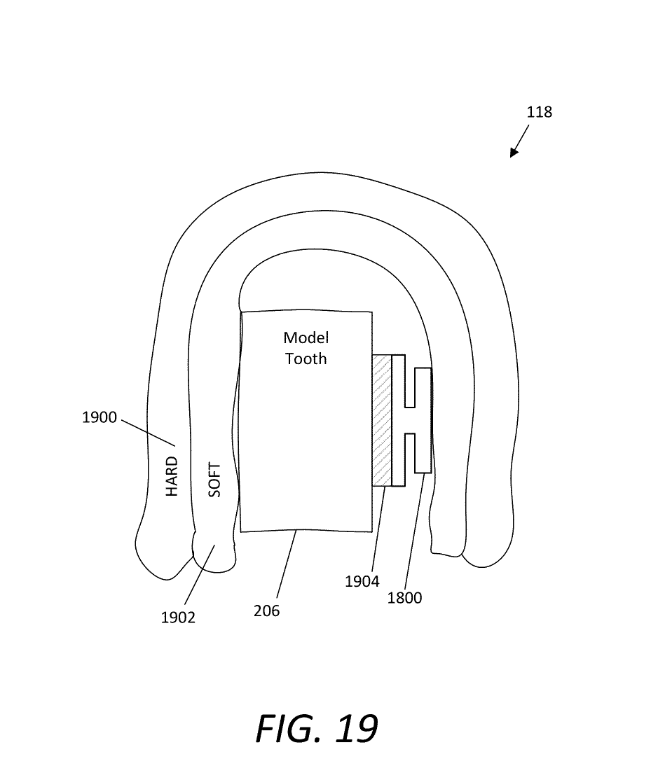

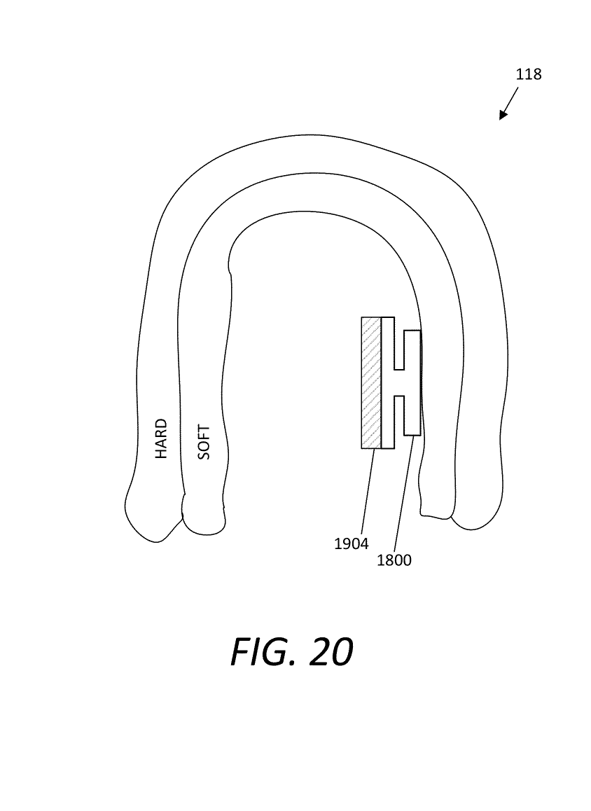

FIG. 17 is a flow chart illustrating example operations performed at a tray assembly station 116. In this example, the tray assembly station 116 includes operations 1700-1704 to place brackets on patient's teeth 206. In operation 1700, the technician T applies brackets onto the physical model of the dentition 114 using bracket guide features 1600. In some embodiments, the technician T applies cement on the base of the brackets as an adhesive to attach the brackets onto the physical model 114. Once all the brackets are attached to the physical model of the dentition 114, the technician forms an indirect bonding tray 1702. The indirect bonding tray is used to transfer the brackets attached to the physical model of the dentition 114 to the patient's teeth 206 while maintaining their original positions determined in method 530. The indirect bonding tray is shown and described in more detail in FIGS. 19-21. After the indirect bonding tray is formed 1702, the technician removes the brackets from the physical model 1704. The removal process is discussed in more detail in FIG. 20.

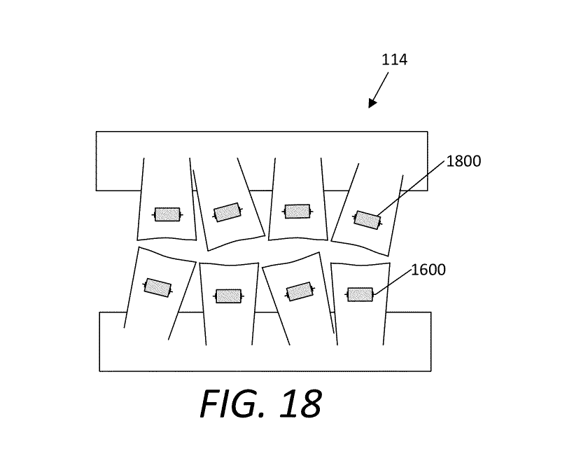

FIG. 18 is a schematic front view of the example physical model of a dentition 114, shown in FIG. 16, including brackets 1800 installed between the bracket guide features 1600.

FIG. 19 is a schematic side cross-sectional view of an example indirect bonding tray 118 formed around the physical model of the dentition and the brackets, as shown in FIG. 18. In some embodiments, the indirect bonding tray is formed using multi-layered materials. In this example embodiment, the indirect bonding tray 118 includes a hard material 1900 and a soft material 1902. The indirect bonding tray 118 surrounds and encapsulates the brackets 1800 which are attached to the teeth 206 using heat-activated cement 1904. The soft material 1902 of the indirect bonding tray 118 is formed placing a sheet of a certain durometer over the stone model 206 and brackets 1800. The stone model 206 and brackets 1800 are then put in a vacu-form that heats up to soften the clear sheet, thereby creating a soft material 1902. Once the soft material 1902 is set, a non-stick material is applied to the soft material 1902 and another sheet with a different durometer is laid over the soft material 1902. The physical model 114 and indirect bonding tray 118 is once again put in a vacu-form that heats to create the hard material 1900.

FIG. 20 is another schematic side cross-sectional view of the example indirect boding tray shown in FIG. 19, being removed from the physical model of the dentition. In this example, once the indirect bonding tray 118 is created, it is removed from the physical model of the dentition, leaving only the tray 118, brackets 1800, and cement 1904. The cement 1904 is then removed from the base of the brackets 1800, such as by dissolving.

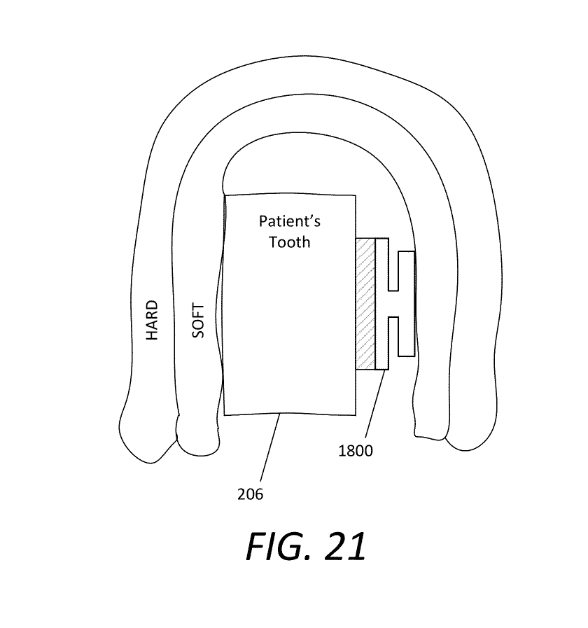

FIG. 21 is another schematic side cross-sectional view of the example indirect bonding tray shown in FIG. 20, being positioned on a patient's dentition. In this example, the indirect bonding tray 118 properly places the brackets 1800 on the patient's teeth 206. Once the brackets are in place, the indirect bonding tray 118 is removed and the patient's teeth 206 are ready for treatment.

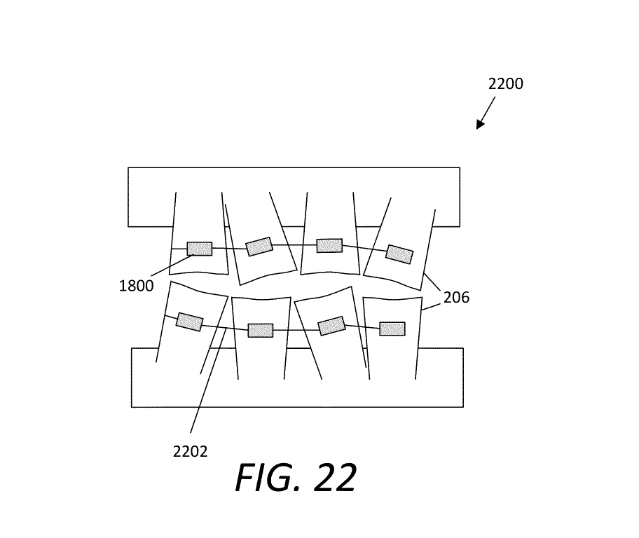

FIG. 22 is a schematic front view of the patient's dentition 2200 having the brackets 1800 and accompanying wires 2202 properly placed on a patient's teeth 206.

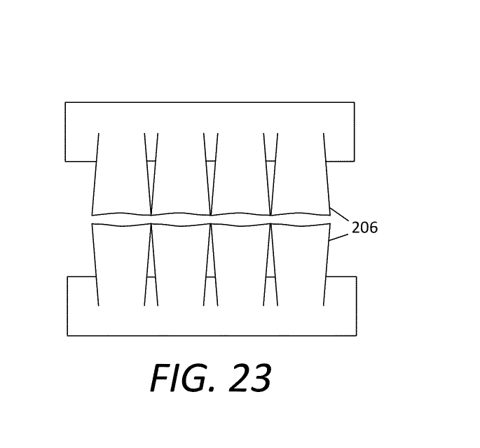

FIG. 23 illustrates the patient's teeth 206 after orthodontic treatment is complete.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of guiding placement of a bracket, the method comprising:
obtaining an electronic model of a dentition, the electronic model defining at least a front surface of a tooth; and
modifying the electronic model to add at least one bracket guide feature to the electronic model at the front surface of the tooth, wherein the bracket guide feature identifies a proper position on the front surface for placement of the bracket.

2. The method of claim 1, further comprising:
generating a physical model of the dentition using the modified electronic model, wherein the physical model of the dentition includes a physical bracket guide feature corresponding to the electronic bracket guide feature.

3. The method of claim 2, wherein the bracket guide feature is a bump.

4. The method of claim 2, wherein the bracket guide feature is an indentation.

5. The method of claim 2, wherein the physical model of the dentition includes at least two physical bracket guide features, the method further comprising:
positioning the bracket on the physical model between and aligned with the at least two physical bracket guide features.

6. A physical model of a dentition, the physical model comprising:
physical models of a plurality of teeth; and
one or more bracket guide features arranged on one or more of the teeth, wherein the bracket guide features are physical structures integral with the physical models of the plurality of teeth.

7. An apparatus for placing bracket guide features on a model dentition to assist in accurate bracket placement, the system comprising:
a dentition scanner that outputs an electronic model of a dentition; and
a tray forming station wherein the tray forming station further includes a bracket guide feature placement engine for placing bracket guide features on the electronic model of the dentition, and a three-dimensional printer for printing a physical model of the dentition with the bracket guide features appropriately placed.

8. A method of placing orthodontic brackets on a patient using bracket guide features, the method comprising:
scanning a patient's dentition to obtain an electronic model of the dentition including at least one tooth in a pre-treatment position;
uploading the electronic model of the dentition in a bracket guide feature placement engine;
adjusting the at least one tooth to a desired post-treatment position;
placing bracket guide features on the at least one tooth in the desired post-treatment position;
readjusting the at least one tooth of the electronic model of the dentition with the bracket guide features to the pre-treatment position;
generating a physical model of the tooth with bracket guide features in the pre-treatment position using a three-dimensional printer;
inserting at least one bracket on the physical model of the at least one tooth using the bracket guide features;
attaching an indirect bonding tray to the at least one bracket on the physical model of the at least one tooth;
removing the indirect bonding tray and the at least one bracket from the physical model of the at least one tooth;
placing the indirect bonding tray and the at least one bracket on the patient; and
removing the indirect bonding tray from the at least one bracket.
